(19) United States
(12) Patent Application Publication
(10) Pub. No.: US 2020/0211220 A1
(43) Pub. Date: Jul. 2, 2020

(54) Method for Identifying an Object Instance and/or Orientation of an Object

(71) Applicant: Siemens Aktiengesellschaft, München (DE)

(72) Inventors: Slobodan Ilic, München (DE); Sergey Zakharov, Kirchseeon (DE)

(73) Assignee: Siemens Aktiengesellschaft, München (DE)

(21) Appl. No.: 16/646,456

(22) PCT Filed: Aug. 15, 2018
(86) PCT No.: PCT/EP2018/072085

§ 371 Date: Mar. 11, 2020

(30) Foreign Application Priority Data
Sep. 22, 2017 (DE) 10 2017 216 821.8

(51) Int. Cl. G06T 7/73; G06K 9/00; G06K 9/62; G06N 3/08; G06F 17/11

(52) U.S. Cl. CPC G06T 7/74; G06K 9/00201; G06K 9/6256; G06T 2207/20081; G06K 9/6215; G06F 17/11; G06N 3/08

(57) ABSTRACT

Various embodiments of the teachings herein may include a method for identifying an object instance and determining an orientation of localized objects in noisy environments using an artificial neural network may include: recording a plurality of images of an object for obtaining a multiplicity of samples containing image data, object identity, and orientation; generating a training set and a template set from the samples; training the artificial neural network using the training set and a loss function; and determining the object instance and/or the orientation of the object by evaluating the template set using the artificial neural network. The loss function includes a dynamic margin.

### CROSS-REFERENCE TO RELATED APPLICATIONS

This application is a U.S. National Stage Application of International Application No. PCT/EP2018/072085 filed Aug. 15, 2018, which designates the United States of America, and claims priority to DE Application No. 10 2017 216 821.8 filed Sep. 22, 2017, the contents of which are hereby incorporated by reference in their entirety.

### TECHNICAL FIELD

The present disclosure relates to computer vision. Various embodiments may include methods for identifying an object instance and/or for determining the orientation of already localized objects in noisy environments as well as systems for performing such methods.

### BACKGROUND

Object instance identification and 3D orientation estimation are well known problems in the field of computer vision. There are numerous applications in robotics and augmented reality. Current methods often have problems with spurious data and masking. They are furthermore sensitive to background changes and illumination changes. The most often used orientation estimation employs a single classifier per object, so that the complexity increases linearly with number of objects. For industrial purposes, however, scalable methods that operate with a large number of different objects are desirable. The most recent advances in object instance identification may be found in the field of 3D object identification, the aim being to extract similar objects from a large database.

Reference is made inter alia to the following documents:

[1] P. Wohlhart and V. Lepetit, “Learning Descriptors for Object Recognition and 3D Pose Estimation,” presented at the Proceedings of the IEEE Conference on Computer Vision and Pattern Recognition, 2015, pp. 3109-3118.

[2] A. Singh, J. Sha, K. S. Narayan, T. Achim, and P. Abbeel, “BigBIRD: A large-scale 3D database of object instances,” in 2014 IEEE International Conference on Robotics and Automation (ICRA), 2014, pp. 509-516.

[3] Z. Wu et al., “3D ShapeNets: A Deep Representation for Volumetric Shapes,” presented at the Proceedings of the IEEE Conference on Computer Vision and Pattern Recognition, 2015, pp. 1912-1920.

[4] D. Maturana and S. Scherer, “VoxNet: A 3D Convolutional Neural Network for real-time object recognition,” in 2015 IEEE/RSJ International Conference on Intelligent Robots and Systems (IROS), 2015, pp. 922-928.

[5] H. Su, S. Maji, E. Kalogerakis, and E. Learned-Miller, “Multi-View Convolutional Neural Networks for 3D Shape Recognition,” presented at the Proceedings of the IEEE International Conference on Computer Vision, 2015, pp. 945-953.

[6] R. Pless and R. Souvenir, “A Survey of Manifold Learning for Images,” IPSJ Trans. Comput. Vis. Appl., vol. 1, pp. 83-94, 2009.

[7] R. Hadsell, S. Chopra, and Y. LeCun, “Dimensionality Reduction by Learning an Invariant Mapping,” in 2006 IEEE Computer Society Conference on Computer Vision and Pattern Recognition (CVPR'06), 2006, vol. 2, pp. 1735-1742.

[8] J. Masci, M. M. Bronstein, A. M. Bronstein, and J. Schmidhuber, “Multimodal Similarity-Preserving Hashing,” IEEE Trans. Pattern Anal. Mach. Intell., vol. 36, no. 4, pp. 824-830, April 2014.

[9] E. Hoffer and N. Ailon, “Deep Metric Learning Using Triplet Network,” in Similarity-Based Pattern Recognition, 2015, pp. 84-92.

[10] H. Guo, J. Wang, Y. Gao, J. Li, and H. Lu, “Multi-View 3D Object Retrieval With Deep Embedding Network,” IEEE Trans. Image Process., vol. 25, no. 12, pp. 5526-5537, December 2016.

[11] Stefan Hinterstoisser, Cedric Cagniart, Slobodan Ilic, Peter Sturm, Nassir Navab, Pascal Fua, and Vincent Lepetit. Gradient response maps for real-time detection of textureless objects. IEEE Transactions on Pattern Analysis and Machine Intelligence, 34(5), 2012.

[12] Ken Perlin. Noise hardware. Real-Time Shading SIGGRAPH Course Notes, 2001.

[13] Hao Su, Charles R Qi, Yangyan Li, and Leonidas J Guibas. Render for cnn: Viewpoint estimation in images using cnns trained with rendered 3d model views. In Proceedings of the IEEE International Conference on Computer Vision, 2015.

The rapid increase in the number of freely available 3D models has given rise to methods that allow a search of large 3D object databases. These methods are referred to as 3D retrieval methods or 3D content retrieval methods, since their aim is to search for similar objects in a 3D query object.

### SUMMARY

Some embodiments of the teachings herein may include a method for identifying an object instance and determining an orientation of localized objects (10) in noisy environments (14) by means of an artificial neural network (CNN), having the steps: recording a plurality of images (x) of at least one object (10) for the purpose of obtaining a multiplicity of samples (s), which contain image data (x), object identity (c) and orientation (q); generating a training set (Sₜᵣₐᵢₙ) and a template set (S_{db}) from the samples; training the artificial neural network (CNN) by means of the training set (Sₜᵣₐᵢₙ) and a loss function (L), determining the object instance and/or the orientation of the object (10) by evaluating the template set (S_{db}) by means of the artificial neural network, characterized in that the loss function (L) used for the training has a dynamic margin (m).

In some embodiments, a triplet (38) is formed from three samples (sᵢ, sⱼ, sₖ), in such a way that a first (sᵢ) and a second (sⱼ) sample come from the same object (10) under a similar orientation (q), a third sample (sₖ) being selected in such a way that the third sample (sₖ) is from a different object (10) than the first sample (sᵢ) or, if it comes from the same object (10) as the first sample (sᵢ), has a dissimilar orientation (q) to the first sample (sᵢ).

In some embodiments, the loss function (L) comprises a triplet loss function (Lₜᵣᵢₚₗₑₜₛ) of the following form:

$${L}_{triplets} = {\sum }_{( {s}_{i} , {s}_{j} , {s}_{k} ) ∈ T} max ( 0.1 - \frac{{‖ f ( {x}_{i} ) - f ( {x}_{k} ) ‖}_{2}^{2}}{{‖ f ( {x}_{i} ) - f ( {x}_{j} ) ‖}_{2}^{2} + m} ) ,$$

where x denotes the image of the respective sample (sᵢ, sⱼ, sₖ), f(x) denotes the output of the artificial neural network, and m denotes the dynamic margin.

In some embodiments, a pair is formed from two samples (sᵢ, sⱼ), in such a way that the two samples (sᵢ, sⱼ) come from the same object (10) and have a similar or identical orientation (q), the two samples (sᵢ, sⱼ) having been obtained under different image recording conditions.

In some embodiments, the loss function (L) comprises a pair loss function (Lₚₐᵢᵣₛ) of the following form:

Lₚₐᵢᵣₛ=Σ₍ₛ_{ᵢ}_{,s}_{_{j)∈P}}∥f(xᵢ)−f(xⱼ)∥₂²,

where x denotes the image of the respective sample (sᵢ, sⱼ) and f(x) denotes the output of the artificial neural network.

In some embodiments, the recording of the object (10) is carried out from a multiplicity of viewing points (24).

In some embodiments, the recording of the object (10) is carried out in such a way that a plurality of recordings are made from at least one viewing point (24), the camera being rotated about its recording axis (42) in order to obtain further samples (40) with rotation information, particularly in the form of quaternions.

In some embodiments, the similarity of the orientation between two samples is determined by means of a similarity metric, the dynamic margin being determined as a function of the similarity.

In some embodiments, the rotation information is determined in the form of quaternions, the similarity metric having the following form:

θ(qᵢ,qⱼ)=2arccos(qᵢ,qᵢ),

where q represents the orientation of the respective sample as a quaternion.

In some embodiments, the dynamic margin has the following form:

$$m = \{ \frac{2 arccos ( {q}_{i} , {q}_{j} )}{n} \begin{matrix}if {c}_{i} = {c}_{j} , \\ else , for n > π\end{matrix} ,$$

where q represents the orientation of the respective sample as a quaternion, c denoting the object identity.

### BRIEF DESCRIPTION OF THE DRAWINGS

Exemplary embodiments of the teachings herein are explained in more detail with the aid of the appended schematic drawings, in which:

FIG. 1 shows examples of various sampling types;

FIG. 2 shows an exemplary representation of a real scene;

FIG. 3 shows an example of a training set and a test set;

FIG. 4 shows an example of a CNN triplet and a CNN pair;

FIG. 5 shows an example of sampling with rotation in the plane;

FIG. 6 shows an example of determination of the triplet loss with a dynamic margin;

FIG. 7 shows Table I of the various test arrangements;

FIG. 8 shows diagrams to illustrate the effect of the dynamic margin;

FIG. 9 shows diagrams to illustrate the effect of the dynamic margin;

FIG. 10 shows diagrams to illustrate the effect of noise;

FIG. 11 shows diagrams to illustrate the effect of different modalities; and

FIG. 12 shows the classification-rate and orientation-error diagrams for three differently trained networks.

### DETAILED DESCRIPTION

The methods described in the teachings of the present disclosure are related to, and may be regarded as a representative of, 3D retrieval methods. In known methods, however, the queries are taken from the context of the real scene and are therefore free of spurious data and masking. In addition, it is usually not necessary to determine the orientation, attitude, or pose of the object, which is essential for further use, for instance gripping in robotics. Lastly, known 3D retrieval benchmarks are aimed at determining only the object class and not the instance of the object, so that use is restricted to data sets for object instance identification.

Since the approach proposed here follows various approaches for manifold learning, most work in the field relating thereto will likewise be considered at the same time. 3D retrieval methods are primarily divided into two classes: model-based and view-based. Model-based methods operate directly by means of 3D models and seek to represent these by various types of features.

View-based methods on the other hand, operate with 2D views of objects. They therefore do not explicitly require 3D object models, which makes this way seem suitable for practical applications. Furthermore, view-based methods profit from the use of 2D images, which makes possible the use of dozens of efficient methods from the field of image processing.

In the past, there has been a wealth of literature that deals with the design of features that are suitable for this task. Recently, the approaches have learned features by means of deep neural networks, usually by means of convolutional neural networks, CNN. The reason for this is that the features learned by task-specific monitoring by means of CNNs show better performance than handmade ones. Some of the popular model-based methods, for instance ShapeNet [3] and VoxNet [4], take binary 3D voxel grids as input for a 3D CNN and output a class of the object. These methods show outstanding performance and are regarded as highly modern model-based methods. It has, however, in demonstrated that even the newest volumetric model-based methods are surpassed by CNN-based approaches with a plurality of views, for instance the method according to Hang Su et al. [5].

The methods described herein may be described as view-based methods, but instead of an object class gives a specific instance (of the object) as output. Furthermore, a certain robustness in relation to background spurious data is necessary since real scenes are used.

Another aspect which has a close relationship with this application is so-called manifold learning [6]. Manifold learning is an approach for nonlinear dimension reduction, motivated by the idea that high-dimensional data, for example images, can be efficiently represented in a space with lower dimension. This concept, using CNNs, is investigating well in [7] on page 20.

In order to learn the mapping, a so-called Siamese network is used, which takes two inputs instead of one, and a specific cost function. The cost function is defined in such a way that, for similar objects, the square of the Euclidean distance between them is minimized and for dissimilar objects, the hinge loss function is used, which forces the objects apart by means of a difference term. In the article, this concept is applied to orientation estimation.

The work [8] extends this idea even further. A system is proposed therein for multimodal similarity-preserving hashing, in which an object which is based on a single or a plurality of modalities, for example text and image, is mapped into another space in which similar objects are mapped as close together as possible and dissimilar objects are mapped as far apart as possible.

The newest manifold learning approaches use the recently introduced triplet networks, which surpass Siamese networks in the generation of well-separated manifolds [9, page 20]. A triplet network, as the name suggests, takes three images as input (instead of two in the case of the Siamese network), two images belonging to the same class and the third to another class. The cost function attempts to map the output descriptors of the images of the same class closer to one another than those of another class. This is meant to allow rapid and robust manifold learning, since both positive and negative examples are taken into within a single runtime.

The method proposed by Paul Wohlhart and Vincent Lepetit [1], inspired by these recent advantages, maps the input image data by means of a triplet CNN with a specially configured loss function directly into the similarity-preserving descriptor space. The loss function imposes two constraints: the Euclidean distance between the views of the dissimilar objects is large, while the distance between the views of objects of the same class is the relative distance with respect to their orientations. The method therefore learns to embed the object views in a descriptor space with lower dimension. Object instance identification is then initiated by an efficient and scalable method for searching for nearest neighbors being applied to the descriptor space, in order to find the nearest neighbors. Furthermore, besides the orientation of the object, the method also finds its identity and therefore solves two separate problems at the same time, which further increases the value of this method.

The approach of [10] adds a classification loss to the triplet loss and learns to embed the input image space into a discriminative feature space. This approach is tailored to the task of an “object class search” and is trained only with the aid of real images and not with the aid of rendered 3D object models.

The teachings of the present disclosure improve these method of identifying an object instance in noisy environments. The teachings describe methods for identifying an object instance and determining an orientation of (already) localized objects in noisy environments by means of an artificial neural network or CNN. Some embodiments include the steps:
recording a plurality of images of at least one object for the purpose of obtaining a multiplicity of samples, which contain image data, object identity and orientation;
generating a training set and a template set from the samples;
training the artificial neural network or CNN by means of the training set and a loss function,
determining the object instance and/or the orientation of the object by evaluating the template set by means of the artificial neural network,

the loss function used for the training having a dynamic margin (m).

In some embodiments, a triplet is formed from three samples, in such a way that a first and a second sample come from the same object under a similar orientation, a third sample being selected in such a way that the third sample is from a different object than the first sample or, if it comes from the same object as the first sample, has a dissimilar orientation to the first sample.

In some embodiments, the loss function comprises a triplet loss function of the following form:

$${L}_{triplets} = {\sum }_{( {s}_{i} , {s}_{j} , {s}_{k} ) ∈ T} max ( 0.1 - \frac{{‖ f ( {x}_{i} ) - f ( {x}_{k} ) ‖}_{2}^{2}}{{‖ f ( {x}_{i} ) - f ( {x}_{j} ) ‖}_{2}^{2} + m} ) ,$$

where x denotes the image of the respective sample, f(x) denotes the output of the artificial neural network, and m denotes the dynamic margin.

In some embodiments, a pair is formed from two samples, in such a way that the two samples come from the same object and have a similar or identical orientation, the two samples having been obtained under different image recording conditions.

In some embodiments, the loss function comprises a pair loss function of the following form:

i Lₚₐᵢᵣₛ=Σ₍ₛ_{ᵢ}_{,s}_{_{j)∈P}}∥f(xᵢ)−f(xⱼ)∥₂²,

where x denotes the image of the respective sample and f(x) denotes the output of the artificial neural network.

In some embodiments, the recording of the object is carried out from a multiplicity of viewing points.

In some embodiments, the recording of the object is carried out in such a way that a plurality of recordings are made from at least one viewing point, the camera being rotated about its recording axis in order to obtain further samples with rotation information, for example in the form of quaternions.

In some embodiments, the similarity of the orientation between two samples is determined by means of a similarity metric, the dynamic margin being determined as a function of the similarity.

In some embodiments, the rotation information is determined in the form of quaternions, the similarity metric having the following form:

θ(qᵢ,qⱼ)=2arccos(qᵢ,qⱼ),

where q represents the orientation of the respective sample as a quaternion.

In some embodiments, the dynamic margin has the following form:

$$m = \{ \begin{matrix}2 arccos ( {q}_{i} , {q}_{j} ) \\ n\end{matrix} \begin{matrix}if {c}_{i} = {c}_{j} , \\ else , for n > π\end{matrix} ,$$

where q represents the orientation of the respective sample as a quaternion, c denoting the object identity.

Here, the approach of [1] is improved; first by introducing a dynamic margin into the loss function, so that more rapid training and shorter descriptors are made possible, and then by producing a rotational invariance by learning rotations in the plane, including surface normals as a strong and complementary modality for RGB-D data.

In some embodiments, a method introduces a dynamic margin into the manifold learning triplet loss function. Such a loss function may be configured to map images of different objects and their orientation into a descriptor space with lower dimension, it being possible to apply efficient nearest-neighbor search methods to the descriptor space. The introduction of a dynamic margin allows more rapid training times and better accuracy of the resulting low-dimensional manifolds.

In some embodiments, rotations in the plane (which are ignored by the baseline method) are included in the training, and surface normals are added as an additional powerful image modality, which represent an object surface and lead to better performance than merely the use of depth allows. An exhaustive evaluation has been carried out in order to confirm the effects of the contributions proposed here. In addition, we evaluate the performance of the method on the large BigBIRD data set [2], in order to demonstrate the good scalability properties of the pipeline in relation to the number of models.

In some embodiments, the order of the method steps does not imply any sequence. The steps are merely provided with letters for better referencability. The steps may consequently also be carried out in any other reasonable combinations, so long as the desired result is achieved.

The data sets used contain the following data: 3D mesh models of a multiplicity of objects 10 and/or RGB-D images 12 of the objects 10 in a real environment 14 with their orientation with respect to the camera. With these data, three sets are generated: a training set Sₜᵣₐᵢₙ, template set S_{db} and a test set Sₜₑₛₜ. The training set Sₜᵣₐᵢₙ is used exclusively for training the CNN. The test set Sₜₑₛₜ is used for evaluation only in the test phase. The template set S_{db} into both in the training phase and in the test phase.

Each of these sets Sₜᵣₐᵢₙ, S_{db}, Sₜₑₛₜ comprises a multiplicity of samples 16. Each sample 16 comprises in particular an image x, an identity c of the object and/or an orientation q, i.e. s=(x; c; q).

In a first layer in order to prepare the data, the samples 16 for the sets Sₜᵣₐᵢₙ, S_{db}, Sₜₑₛₜ are generated. In this case, the sets Sₜᵣₐᵢₙ, S_{db}, Sₜₑₛₜ are generated from two types of image data 18: real images 20 and synthetic images 22. The real images 20 represent the objects 10 in the real environment 14 and are generated with a commercially available RGB-D sensor, for example Kinect or Primesense. The real images 20 may be provided with the data sets.

The synthetic images 22 are initially unavailable, and are generated by rendering of textured 3D mesh models.

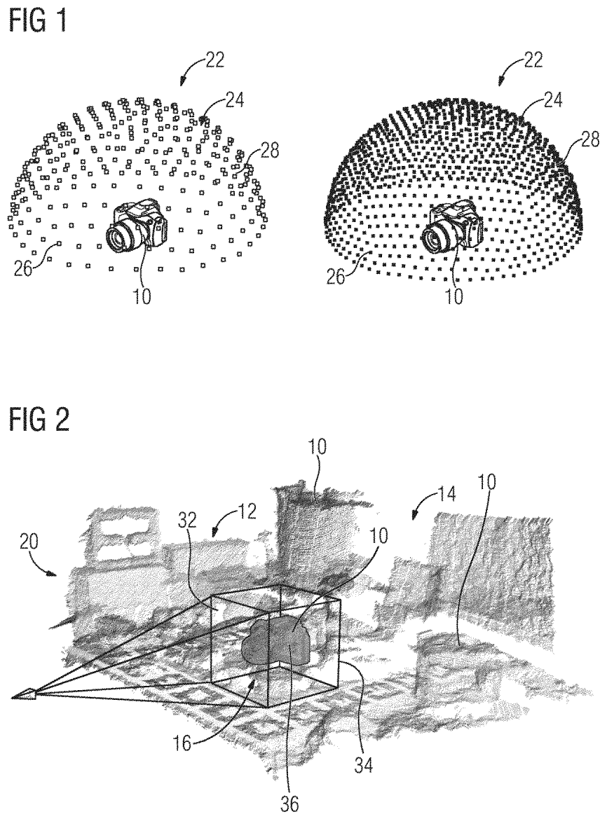

Reference is subsequently made to FIG. 1. With the given 3D models of the objects 10, these are generated from different viewing points 24, which cover the upper part of the object 10, in order to generate the synthetic images 22. In order to define the viewing points 24, an imaginary icosahedron is placed on the object 10, each vertex 26 defining a camera position 28, or a viewing point 24. In order to obtain finer sampling, each triangle is subdivided recursively into four triangles. Two different sampling types are therefore defined: coarse sampling, which is represented in FIG. 1, left and may be achieved by two subdivisions of the icosahedron, and/or fine sampling, which is represented in FIG. 1, right and may be achieved by three successive subdivisions. The coarse sampling is used in order to generate the template set S_{db}, while in particular the fine sampling is used for the training set Sₜᵣₐᵢₙ.

For each camera position 28, or each vertex 26, an object 10 is preferably rendered against a blank background 30, for example black. Preferably, the RGB and the depth channel are stored.

Reference is made in particular to FIG. 2. As soon as all the synthetic images 22 have been generated and the real images 20 are also available, samples 16 can be generated. For each image 20, 22, a small region 32 is extracted, which covers the object 10 and is centered around the object 10. This is achieved, for instance, by virtual placement of a cube 34, which is in particular centered on the centroid 36 of the object 10 and, for example, has a size of 40 cm³.

As soon as all regions 32 have been extracted, the regions 32 may be normalized. The RGB channels may be normalized to a mean of 0 and a standard deviation of 1. The depth channel may be mapped onto the interval [−1; 1], everything beyond this in particular being capped. Finally, each region 32 is stored as an image x in addition to the identity of the object 10 and its orientation q in a sample 16.

In the next step, the samples 16 may be divided accordingly between the training set Sₜᵣₐᵢₙ, the template set S_{db} and the test set Sₜₑₛₜ. The template set S_{db} contains, in particular, only synthetic images 22, e.g. based on the coarse sampling.

The coarse sampling may be used both in the training phase (in order to form triplets 38) and the test phase (as a database of the search for nearest neighbors). The samples 16 of the template set S_{db} define a search database on which the search for nearest neighbors is later carried out. One of the reasons for the use of the coarse sampling is specifically to minimize the size of the database for a more rapid search. However, the coarse sampling for the template set S_{db} also directly limits the accuracy of the orientation estimation.

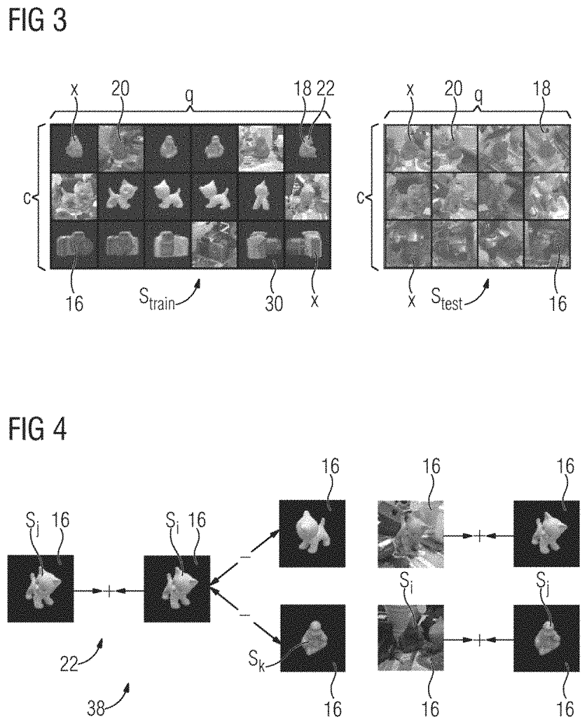

Reference is made in particular to FIG. 3. The training set Sₜᵣₐᵢₙ comprises a mixture of real images 20 and synthetic images 22. The synthetic images 22 represent samples 16 which come from the fine sampling. In some embodiments, about 50% of the real images 20 are added to the training set Sₜᵣₐᵢₙ. These 50% are selected by taking those real images 20 which lie close to the samples 16 of the template set S_{db} in terms of orientation. The other real images 20 are stored in the test set Sₜₑₛₜ, which is used for estimating performance capability of the method.

As soon the training set Sₜᵣₐᵢₙ and the template set S_{db} have been generated, sufficient data are available for training the CNN. Furthermore, an input format may be established for the CNN, which is defined by the loss function of the CNN. In the present case, the loss function is as the sum of two separate loss terms:

L=Lₜᵣᵢₚₗₑₜₛ+Lₚₐᵢᵣₛ .(1)

Reference is made in particular to FIG. 4. The first summand Lₜᵣᵢₚₗₑₜₛ is a loss term which is defined over a set T of triplets 38, a triplet 38 being a group of samples 16 (sᵢ; sⱼ; sₖ) such that sᵢ and sⱼ always come from the same object 10 with a similar orientation, and sk is based either on another object 10 or on the same object 10 and but with a less similar orientation. In other words, an individual triplet 38 comprises a pair of similar samples sᵢ, sⱼ and a pair of dissimilar samples sᵢ, sₖ.

As used, the sample sᵢ is also referred to as an “anchor”, example sⱼ as a positive sample or “puller” and the sample sₖ as a negative sample or “pusher”. The triplet loss component Lₜᵣᵢₚₗₑₜₛ has the following form:

$${L}_{triplets} = {\sum }_{( {s}_{i} , {s}_{j} , {s}_{k} ) ∈ T} max ( 0.1 - \frac{{‖ f ( {x}_{i} ) - f ( {x}_{k} ) ‖}_{2}^{2}}{{‖ f ( {x}_{i} ) - f ( {x}_{j} ) ‖}_{2}^{2} + m} ) \qquad ( 2 )$$

where x is the input image of a particular sample, f(x) is the output of the neural network with input of the input image x, m is the margin and N is the number of triplets 38 in the stack.

The margin term introduces the margin for the classification and represents the minimum ratio of the Euclidean distance of the similar and dissimilar pairs of samples 16. By minimizing Lₜᵣᵢₚₗₑₜₛ, two properties that are intended to be achieved can be implemented, namely: on the one hand maximizing the Euclidean distance between descriptors of two different objects, and on the other hand adjusting the Euclidean distance between descriptors of the same object 10, so that they are representative of the similarity of their orientation.

The second summand Lₚₐᵢᵣₛ is a pairwise term. It is defined over a set P of sample pairs (sᵢ; sⱼ). Samples within an individual pair come from the same object 10, with either a very similar orientation or the same orientation with different image recording conditions. Different image recording conditions may comprise—but are not restricted to: illumination changes, different backgrounds and spurious data. It is also conceivable for one sample to come from a real image 20 while the other comes from a synthetic image 22. The aim of this term is to map two samples as close to one another as possible:

$${L}_{pairs} = {\sum }_{( {s}_{i} , {s}_{j} , {s}_{k} ) ∈ P} {‖ f ( {x}_{i} ) - f ( {x}_{j} ) ‖}_{2}^{2}$$

By minimizing Lₚₐᵢᵣₛ, or the Euclidean distance between the descriptors, the CNN learns to handle the same object identically under different image recording conditions by the objects 10 being mapped onto essentially the same point. Furthermore, minimization can ensure that samples with a similar orientation are set close to one another in the descriptor space, which in turn is an important criterion for the triplet term Lₜᵣᵢₚₗₑₜₛ.

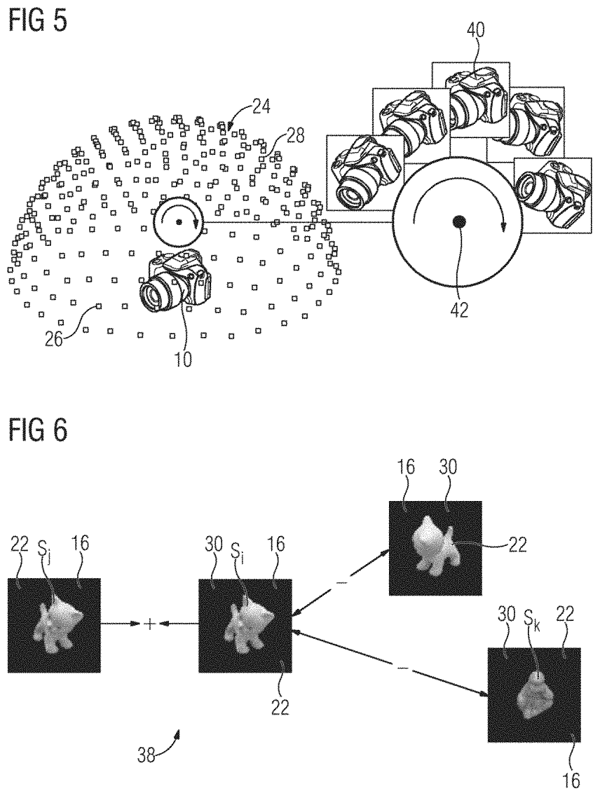

Previous methods do not use rotations in the plane or leave an additional degree of freedom neglected. However, this can scarcely be neglected during the application, for example in robotics. Reference is made in particular to FIG. 5. In order to include rotations in the plane as well, additional samples 40 with rotations in the plane are preferably generated. Furthermore, a metric may be defined in order to compare the similarity between the samples 16, 40 and construct the triplets 38.

In order to generate the samples, at each viewing point 24, the field of view of camera is rotated about the recording axis 42 and a sample is recorded with a particular frequency. For example, in particular seven samples 40 per vertex 26 are generated, in the range of between −45° and +45° with an increment angle of 15°.

The rotations Q of the objects 10, or models, are represented by means of quaternions, the angle between the quaternions of the compared samples serves as an orientation comparison metric Θ(qᵢ, qⱼ)=2 arccos (qᵢ·qⱼ).

The aforementioned triplet loss function, as is used for example in [1], is a constant margin term and therefore always the same for different types of negative samples. Precisely the same margin term is therefore applied to objects of the same and different classes, while the aim is to map the objects 10 from different classes further away from one another. The training in terms of the classification is therefore slowed and the resulting manifold has an inferior separation.

In some embodiments, if the negative sample belongs to the same class as the anchor, the margin term is set to the angular distance between these samples. If the negative sample belongs to another class, however, the distance is set to a constant value, which is greater than the possible maximum angle difference. The effect of this dynamic margin is illustrated in FIG. 6.

The improved loss function is defined below:

$$\begin{matrix}{L}_{triplets} = {\sum }_{( {s}_{i} , {s}_{j} , {s}_{k} ) ∈ T} max ( 0.1 - \frac{{‖ f ( {x}_{i} ) - f ( {x}_{k} ) ‖}_{2}^{2}}{{‖ f ( {x}_{i} ) - f ( {x}_{j} ) ‖}_{2}^{2} + m} ) & ( 4 ) \\ where m = \{ \frac{2 arccos ( {q}_{i} , {q}_{j} )}{n} \begin{matrix}if {c}_{i} = {c}_{j} , \\ else , for n > π\end{matrix} & \end{matrix}$$

Surface normals may be used as a further modality, which represents an image of the object 10, specifically in addition to the RGB and depth channels already taken into account. A surface normal at the point p is defined as a 3D vector which is orthogonal to the tangent plane to the model surface at the point p. Applied to a multiplicity of points of the object model, the surface normal give a high-performance modality which describes the curvature of the object model.

In some embodiments, surface normals may be generated on the basis of the depth-map images, so that no further sensor data are required. For example, the method known from [11] may be used in order to obtain a rapid and robust estimation. With this configuration, smoothing of the surface noise may be carried out, and therefore also a better estimation of surface normals in the vicinity of depth irregularities.

One challenging task is the treatment of spurious data and different backgrounds in images. Since our samples 16, 40 initially have no background, the CNN can be adapted only with difficulty real data with full noise and spurious data in the foreground and background. One approach is to use real images 20 for the training. If no or only few real images 20 are available, the CNN must be introduced to the ignoring and/or simulation of background in another way. In the present case, at least one noise is selected from a group which contains: white noise, random shapes, gradient noise and real backgrounds.

For white noise, a floating-point number between 0 and 1 is generated from a uniform distribution for each pixel and added thereto. In the case of RGB, this process is repeated for each color, i.e. three times in total.

For the second type of noise, the idea is to represent the background objects in such a way that they have similar depth and color values. The color of the objects is in turn sampled from uniform distribution between 0 and 1, the position being sampled from uniform distribution between 0 and the width of the sample image. This approach may also be used to represent foreground noise by placing random shapes onto the actual model.

The third type of noise is fractal noise, which is often used in computer graphics for texture or landscape generation. Fractal noise may be generated as described in [12]. It gives a uniform series of pseudorandom numbers and avoids drastic intensity changes such as occur with white noise. Overall, this is close to a real scenario.

Another type of noise is real backgrounds. Instead of generating noise, RGB-D images of real backgrounds are in a similar way as in [13]. From a real image 20, a region 32 is sampled with the required size and used as a background for a synthetically generated model. This modality is useful, in particular, when the type of environment in which the objects are arranged is known in advance.

One disadvantage of the baseline method is that the stack is generated and stored before execution. This means that the same backgrounds are always used for each epoch so that the variability is restricted. It is proposed to generate the stack online. At each iteration, the background of the selected positive sample is filled with one of the available modalities.

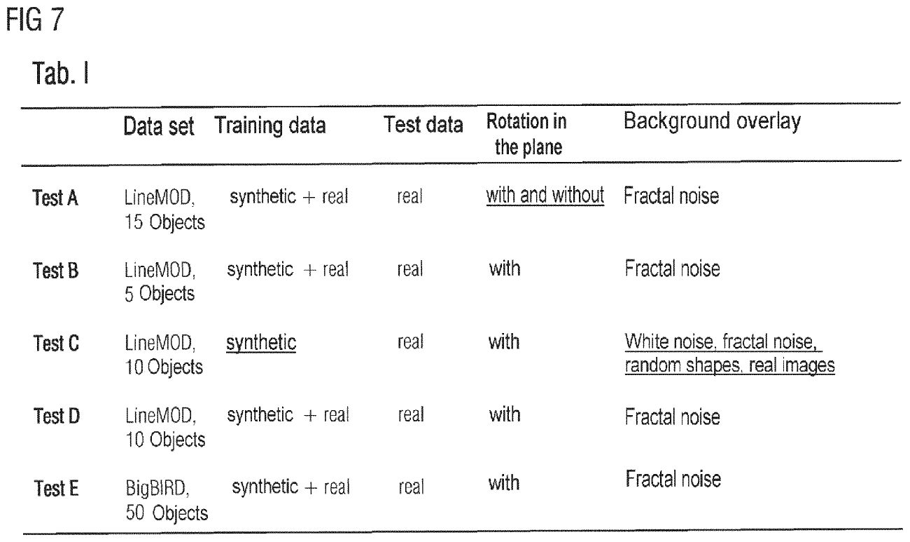

A series of tests was carried out in order to evaluate the effect of the newly introduced modifications, for example rotation in the plane, surface normals, background noise types. Furthermore, the performance capability of the method was tested on a relatively large data set (BigBIRD) and on the set of real required data, which are sufficiently meaningful. It should be noted that all tests were carried out with same network architecture as in [1] and dynamic margin, unless otherwise indicated. The results are in FIG. 7, Table I.

As already described, [1] does not take rotations in the plane into account. These, however, are important for application in real scenarios. Here, the performance of the following networks is compared: a CNN which takes rotations in the plane into account during training, and a CNN which does not take them into account during training.

Results: with this setup, the two CNNs mentioned above are compared, the one without rotations in the plane being denoted as baseline and the other as baseline+ (see Table II).

TABLE II
Comparison of the CNN trained with rotations (baseline+)
with the CNN trained without rotations (baseline)

| | Angle error | | | |
|---|---|---|---|---|
| | 10° | 20° | 40° | Classification |
| baseline | 34.6% | 63.8% | 73.7% | 81.9% |
| baseline+ | 60% | 93.2% | 97% | 99.3% |

Evaluation is carried out only for one nearest neighbor. As may be seen from Table II, a significant improvement took place in comparison with the results of the known exemplary embodiment. The results also show successful adaptation to an additional degree of freedom.

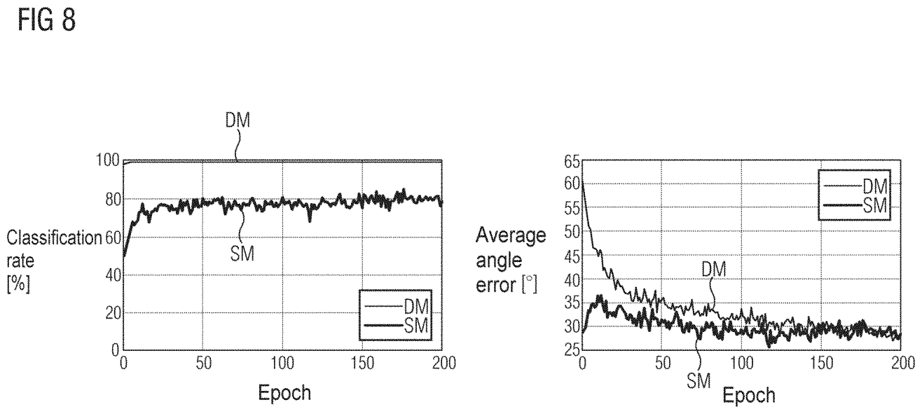

Reference is made in particular to FIG. 8. In order to evaluate the new loss function with a dynamic margin DM, a test series was carried out for comparison with the previous loss function SM. In particular, two tests were carried out on five LineMOD objects by means of the most high-performance training configurations for 3- and 32-dimensional output descriptors.

Results: FIG. 8 compares the classification rate and the average angle error for correctly classified samples over a set of training epochs (one run through the training set Sₜᵣₐᵢₙ) for both embodiments, i.e. the CNNs which have a loss function with a static (SM) and dynamic margin (DM).

As may be seen clearly from the results, the new loss function makes a vast difference to the end result. This makes it possible for the CNN to achieve a better classification much more rapidly in comparison with the original. While almost 100% classification accuracy is achieved substantially more rapidly with the dynamic margin, the known implementation remains at about 80%. It may furthermore be seen from FIG. 8 that the same angle error is obtainable for about 20% more correctly classified.

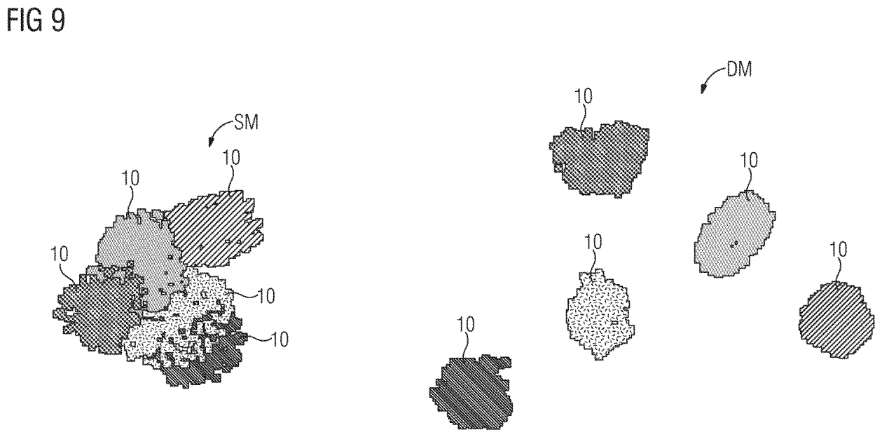

FIG. 9 shows the test samples which by means of the descriptor network, CNN, which was trained with the old (left) and the new (right) loss function. The difference in the degree of separation of the objects may be seen clearly: right figure, the objects are well separated and obtain the minimum margin separation, which leads to a perfect classification score; the left figure still shows object structures which are well discriminatable, but are placed close together and sometimes overlap, which causes a classification confusion, which has been quantitatively estimated in FIG. 8.

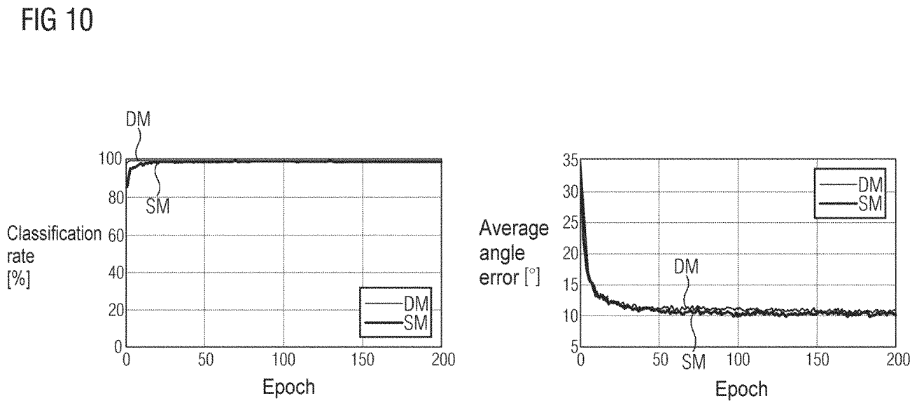

In practice, however, higher-dimensional descriptor spaces are used, which increases both the classification accuracy and the angle accuracy. FIG. 10 shows the same diagrams as FIG. 8, but for a descriptor space with higher dimension, for example 32D. This results in a significant quality jump for both modalities. However, the trend remains the same: the method according to the invention learns the classification much more rapidly and allows the same angle accuracy of a larger number of correctly classified test samples.

Since, in practical application, real RGB-D images are often not available, but rather only 3D models are provided, it is beneficial to use real data for the training. The purpose of this test is also to show how well the CNN adapts to real data while using only synthetic samples with an artificially filled background. In particular, the noise types described above are compared.

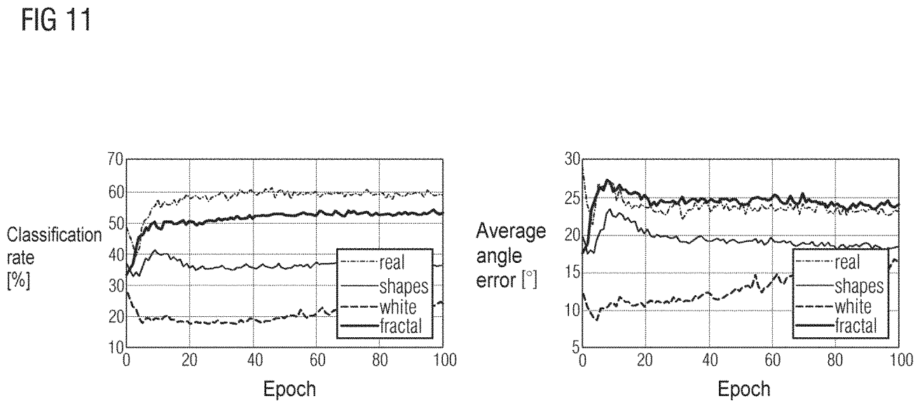

Results: FIG. 11 shows the classification and orientation accuracies for the various noise types. White noise shows the worst results overall with only a 26% classification accuracy. Since 10% accuracy is already achieved in the random sampling of objects from a uniform distribution, this is no great improvement.

With the “random shapes” modality, better results are obtained which fluctuate around 38% classification accuracy. The fractal noise shows the best results among the synthetic background noise types; it achieves up to a 54% identification rate. The modality with real images 20 surpasses the fractal noise in terms of classification and furthermore also shows a better orientation accuracy for a larger number of correctly classified samples. As a result, it is therefore the best option to fill the backgrounds with real images 20 which have similar environments as in the test set Sₜₑₛₜ. Fractal noise is to be regarded as a second preferred option.

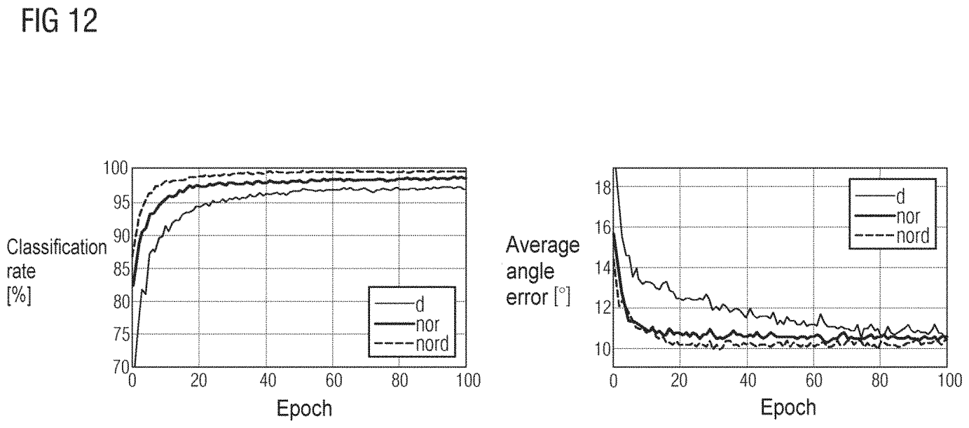

Reference is made to FIG. 12. In this test, the effect of the newly introduced surface normal channel is shown. For comparison, three input image channels are used, namely, depth, normals and a combination thereof. More precisely, the regions 32 which are represented exclusively by the aforementioned channels are preferably used for the training.

Results: FIG. 12 shows the classification-rate and orientation-error diagrams for three differently trained networks: depth (d), normals (nor), and depth and normals (nord). It may be seen that the network CNN with surface normals scores much better than the CNN with depth maps. The surface normals are generated fully on the basis of the depth maps. No additional sensor data are required. Furthermore, the result is even better when depth maps and surface normals are used simultaneously.

The aim of the test on the large data sets is how well the method can be generalized to larger number of models. In particular, the way in which an increased set of models during the training influences the overall performance was examined.

Results: the CNN was training with 50 models of the BigBIRD data set. After the end of the training, results in table III achieve:

TABLE III
Angle error histogram calculated with the samples
of the test set for a single nearest neighbor.

| Angle error | | | |
|---|---|---|---|
| 10° | 20° | 40° | Classification |
| 67.7% | 91.2% | 95.6% | 98.7% |

Table III shows a histogram of classified test samples for same tolerated angle errors. As may be seen, for 50 models, each being representative of about 300 test samples, a classification accuracy of 98.7% and a very good angle accuracy are obtained. As a result, the method therefore scales in such a way that it is compatible with industrial applications.

The method described herein has an improved learning speed, robustness in terms of spurious data and usability in industry. A new loss function with a dynamic margin allows more rapid learning of the CNN and a greater classification accuracy. Furthermore, the method uses rotations in the plane and new background noise types. In addition, surface normals may be used as a further high-performance image modality. An efficient method for generating stacks has also be proposed, which allows greater variability during training.

What is claimed is:

1. A method for identifying an object instance and determining an orientation of localized objects in noisy environments using an artificial neural network, the method comprising:
recording a plurality of images of an object for obtaining a multiplicity of samples containing image data, object identity, and orientation;
generating a training set and a template set from the samples;
training the artificial neural network using the training set and a loss function; and
determining the object instance and/or the orientation of the object by evaluating the template set using the artificial neural network;
wherein the loss function includes a dynamic margin.

2. The method as claimed in claim 1, further comprising:
forming a triplet from three samples wherein a first sample and a second sample come from the object under a similar orientation; and
a third sample is from a different object or, from the same object with a dissimilar orientation to the first sample.

3. The method as claimed in claim 2, wherein the loss function comprises a triplet loss function of the following form:
$${L}_{triplets} = {\sum }_{( {s}_{i} , {s}_{j} , {s}_{k} ) ∈ T} max ( 0.1 - \frac{{‖ f ( {x}_{i} ) - f ( {x}_{k} ) ‖}_{2}^{2}}{{‖ f ( {x}_{i} ) - f ( {x}_{j} ) ‖}_{2}^{2} + m} ) ,$$
where x denotes the image of the respective sample, f(x) denotes the output of the artificial neural network, and m denotes the dynamic margin.

4. The method as claimed in claim 1, further comprising forming a pair from two samples from the same object with a similar or identical orientation;
wherein the two samples were obtained under different image recording conditions.

5. The method as claimed in claim 4, wherein the loss function comprises a pair loss function of the following form:
Lₚₐᵢᵣₛ=Σ₍ₛ_{_{i,}}ₛ_{_{j)∈P}}∥f(xᵢ)−f(xⱼ)∥₂²,
where x denotes the image of the respective sample and f(x) denotes the output of the artificial neural network.

6. The method as claimed in claim 1, wherein the recording of the object is carried out from a multiplicity of viewing points.

7. The method as claimed in claim 1, wherein:
the recording of the object produces a plurality of recordings from a viewing point; and
the camera is rotated about a recording axis to obtain further samples with rotation information.

8. The method as claimed in claim 7, further comprising determining a similarity of the orientation between two samples using a similarity metric; and
determining a dynamic margin as a function of the similarity.

9. The method as claimed in claim 8, wherein the rotation information is determined in the form of quaternions, the similarity metric having the following form:
θ(qᵢ,qⱼ)=2arccos(qᵢ,qⱼ),
where q represents the orientation of the respective sample as a quaternion.

10. The method as claimed in claim 9, wherein the dynamic margin has the following form:
$$m = \{ \frac{2 arccos ( {q}_{i} , {q}_{j} )}{n} \begin{matrix}if {c}_{i} = {c}_{j} , \\ else , for n > π\end{matrix} ,$$
where q represents the orientation of the respective sample as a quaternion, c denoting the object identity.
